(19) United States
(12) Patent Application Publication
(10) Pub. No.: US 2003/0182967 A1
(43) Pub. Date: Oct. 2, 2003

(54) Method for making flat elliptic thin glass tube for discharge tube

(75) Inventors: Akira Tokai, Kakogawa (JP); Hitoshi Yamada, Akashi (JP); Manabu Ishimoto, Kobe (JP); Kenji Awamoto, Miki (JP); Tsutae Shinoda, Akashi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/386,715

(22) Filed: Mar. 13, 2003

(30) Foreign Application Priority Data
Mar. 28, 2002 (JP) 2002-090510

(51) Int. Cl. C03B 23/13

(52) U.S. Cl. 65/108

(57) ABSTRACT

A flat elliptic thin glass tube for a discharge tube is produced by the following steps: (a) a cylindrical glass tube is hermetically sealed; (b) the cylindrical glass tube is heated and deformed in a mold by an increased internal pressure of the glass tube caused by the heating of the glass tube to form a flat elliptic glass tube, the mold having means for defining at least the minor axis of the flat elliptic glass tube; and (c) the flat elliptic glass tube is heated and drawn to form the flat elliptic thin glass tube.

### BACKGROUND OF THE INVENTION

1. Field of the Invention

The present invention relates to methods for making glass discharge tubes having a flat elliptic cross-section. In particular, the present invention relates to a method for making an elliptic thin glass tube at high accuracy and low cost.

2. Description of the Related Art

Glass tubes having a flat elliptic cross-section have been generally formed by tube drawing called a Danner process. In the method for making glass tubes by the Danner process shown in FIG. 7, a molten glass material that is melt in a melting furnace (not shown) at 1,300° C. to 1,500° C. in introduced into a platinum cylinder called a sleeve 74 to form a cylindrical glass tube, and the cylindrical glass tube passes through a shaping unit 72 at a temperature above the softening point of the glass in a production line. The shaping unit 72 has at least a pair of upper and lower rollers 73. The glass tube is pressed by the upper and lower rollers 73 to be deformed into a flat elliptic cross-section.

Unfortunately, the flat elliptic glass tubes directly produced by the Danner process from the molten glass exhibits poor shaping stability. Furthermore, it is difficult to produce thin glass tubes with an inner diameter of about 0.5 mm to 5 mm with high accuracy by the Danner process.

General glass tubes produced under predetermined processes have high productivity, for example, several tens of tons every day; hence, yearly required amounts of glass tubes could be produced within several days. However, control of the shape of flat elliptic glass tubes requires many hours. Thus, production dedicated to fine discharge tubes inevitably consumes much expense.

### SUMMARY OF THE INVENTION

An object of the present invention is to provide a method for readily making a flat elliptic thin glass tube at high accuracy and low cost prefaerably the tube having an inner diameter of about 0.5 mm to 5 mm.

The present inventors made flat elliptic glass tubes by sealing their two ends of inexpensive glass tubes with a circular cross-section formed by a Danner process and then shaping the glass tubes in a shaping unit that determines their outer shape. The cross-section and the thickness of each flat elliptic glass tube were proportionally contracted by a redrawing process to produce a flat elliptic thin glass tube for a discharge tube. The present invention has been accomplished based on these experiments.

According to the present invention, a method for making a flat elliptic thin glass tube for a discharge tube includes the following steps of (a) hermetically sealing a cylindrical glass tube; (b) heating and deforming the cylindrical glass tube in a mold by an increased internal pressure of the glass tube caused by the heating of the glass tube to form a flat elliptic glass tube, the mold having means for defining at least the minor axis of the flat elliptic glass tube; and (c) drawing while heating the flat elliptic glass tube to form the flat elliptic thin glass tube.

Preferably, in the step (b), the cylindrical glass tube is maintained at a temperature which is 70% to 90% of the softening point of the glass tube.

Preferably, in the step (c), the length of a region at a maximum temperature of a heating path for heating the flat elliptic glass tube is 10% or less of the total length of the heating path.

Preferably, the maximum temperature of the heating path is 1.07 times to 1.1 times the softening point of the flat elliptic glass tube.

Preferably, the maximum temperature of the heating path is 1.08 times to 1.09 times the softening point of the flat elliptic glass tube.

Preferably, the heating rate is in the range of 10° C./min to 300° C./min in a heating portion of the heating path.

Preferably, in the step (c), the feeding rate of the flat elliptic thin glass tube is 20 times to 400 times the feeding rate of the flat elliptic glass tube.

According to the present invention, a flat elliptic thin glass tube with a predetermined size and shape is readily produced at high accuracy and low cost by using a commercially available inexpensive cylindrical glass tube. Discharge tubes formed of this flat elliptic thin glass tube have a stable size and shape and thus exhibit uniform discharge characteristics. The discharge tubes are preferably used in a display apparatus.

### BRIEF DESCRIPTION OF THE DRAWINGS

FIG. 1 shows a schemetivally perspective view of a display device including flat elliptic thin glass tubes produced by a method according to the present invention;

FIG. 2 shows a schemetivally perspective view of an apparatus for making a flat elliptic glass tube;

FIGS. 3A to 3C show schemetivally cross-sectional views of the apparatus shown in FIG. 2;

FIG. 4 shows a schemetivally schematic illustration of an apparatus for making a flat elliptic thin glass tube;

FIG. 5 is a graph showing a temperature profile in a heating furnace used in an experiment for making a thin glass tube according to the present invention;

FIGS. 6A and 6B show a schemetivally front view and a schemetivally side view, respectively, of a redrawing apparatus for making a thin glass tube according to the present invention; and

FIG. 7 shows a schemetivally schematic illustration of a conventional Danner process for making an elliptic glass tube.

### DESCRIPTION OF THE PREFERRED EMBODIMENTS

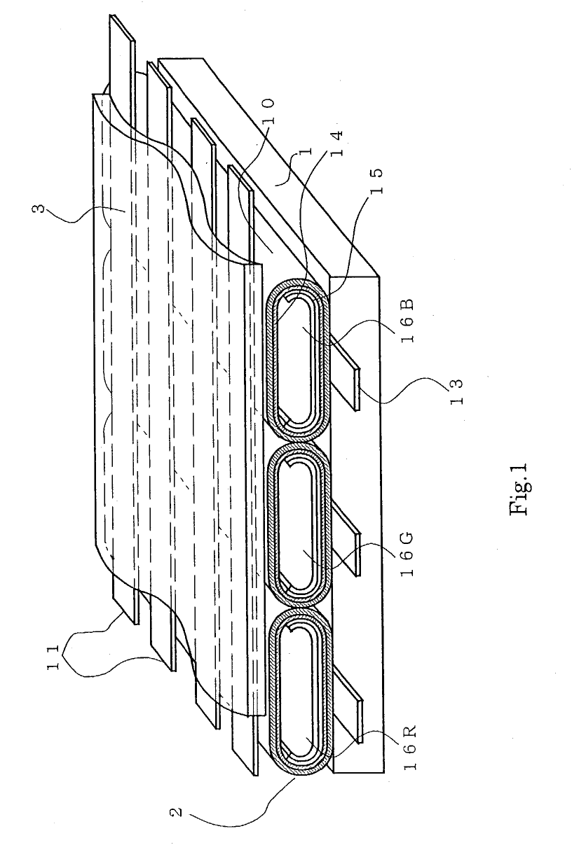

FIG. 1 is a perspective view of a display device including flat elliptic thin glass tubes produced by the method according to the present invention. A rear support 1 composed of a resin or glass substrate is provided with a plurality of data electrodes 13 (three electrodes for displaying red, green, and blue colors, respectively are drawn in the drawing) thereon. Hereinafter, red, green and blue colors are referenced as R, G, and B, respectively. R tube, for example, means a tube for red color. R, G, and B flat elliptic thin glass tubes produced by a method described below are in contact with the respective data electrodes 13. Plural pairs of display electrodes 11 perpendicular to electrodes 13 are arranged on a transparent sheet 3; the outer face of each flat elliptic thin glass tube 2 is in contact with the corresponding data electrode 13 at the bottom and with the display electrodes 11 at the top. The display electrodes 11 are covered with the transparent sheet 3 that functions as a front support. The transparent sheet 3 is bonded to the thin glass tubes with an adhesive layer (not shown). Although is not shown in the drawing, each display electrode 11 has a composite structure including a transparent electrode and a metal bus electrode to reduce its line resistance and the shading area so that visual light can be effectively emitted through the thin glass tubes.

Each thin glass tube is filled with discharge gas and has an electron-emitting layer 14 and three primary color fluorescents layers 16R, 16G, and 16B on the inner wall. These fluorescents layers 16R, 16G, and 16B are preliminarily formed on a fluorescent support 15 and the flourescent support 15 is placed at a predetermined position in the thin glass tube.

For performing display, selective discharge is generated between a data electrode 13 in contact with a selected thin glass tube and a pair of display electrodes 11 and then continuous discharge is generated between the pair of display electrodes 11.

A method for making the above flat elliptic thin glass tube will now be described according to the steps.

Steps for Making Flat Elliptic Glass Tube

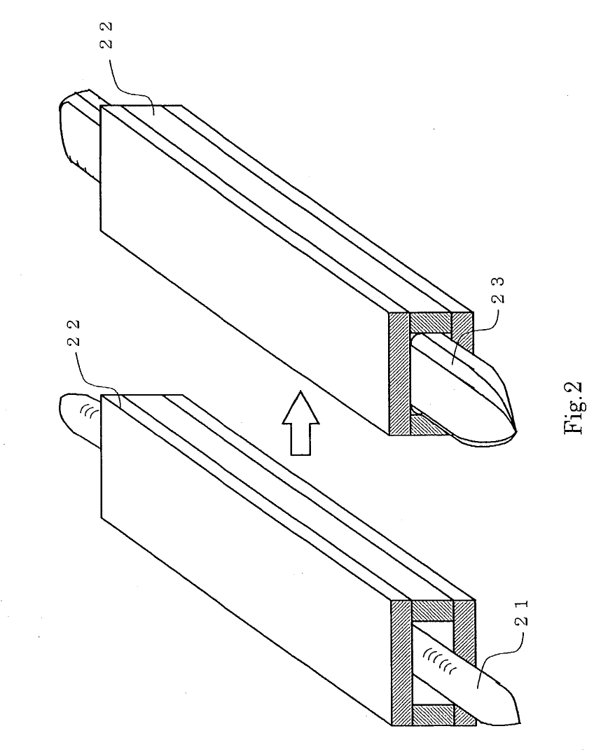

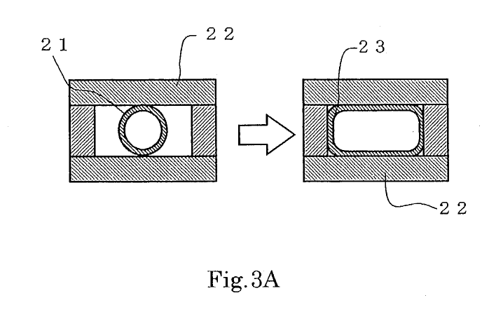

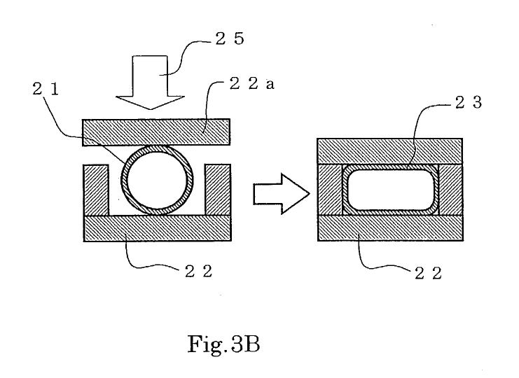

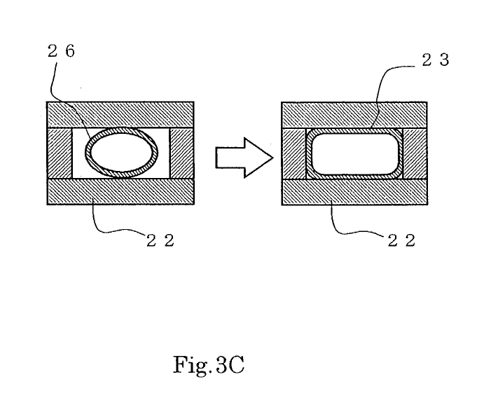

FIG. 2 is a perspective view of an apparatus for making the flat elliptic glass tube, and FIGS. 3A to 3C are cross-sectional views of the apparatus.

Referring to the left in FIG. 2, both sides of a glass tube 21 (Pyrex #7740 made by Corning, diameter: 10 mm, thickness: 1.0 mm, length: 500 mm, softening point: 821° C.) are sealed by melting. The sealed glass tube 21 is placed into a 500 mm long shaping unit 22 composed of carbon, quartz, or silicon carbide and having a rectangular cross-section of 8.6 mm by 11.8 mm. The two ends of the sealed glass tube 21 may put into the shaping unit 22 or may lie outside the shaping unit 22, as shown in the drawing. FIG. 3A shows a state of the glass tube 21 in the shaping unit 22.

The glass tube 21 in the shaping unit 22 is placed in a heating furnace (not shown in the drawing) and is heated to 640° C to cause deformation of the glass tube 21 into a shape (flat elliptic cross-section) all along the inner shape of the shaping unit 22 due to an increased inner pressure and the softening of the glass tube 21, as shown in the right in FIG. 2 and FIG. 3A. After the deformation of the glass tube 21, the glass tube 21 with the shaping unit 22 is cooled. A flat elliptic glass tube 23 is thereby formed. Since the glass tube is more rapidly cooled than air in the tube in the cooling process, the glass tube 23 maintains its flat elliptic cross-sectional shape. Preferably, the maximum temperature of the heating furnace is in the range of 600° C. to 720° C. for Pyrex glass or is in the range of 70% to 90% of the softening point for other glass materials.

Referring to FIG. 3B, the glass tube 21 that is placed into the shaping unit 22 may have an outer diameter larger than the short side of the shaping unit 22. In such a case, the glass tube 21 in the shaping unit 22 is placed in the heating furnace in a state that one side plate 22a of the shaping unit 22 is separated from other portions. A predetermined pressure 25 applied from the side 22a causes deformation of the softened glass tube 21 into a flat elliptic cross-sectional shape along the cross-sectional shape of the shaping unit 22.

Referring to the left in FIG. 3C, alternatively, a flat elliptic glass tube 26 may be used for forming the flat elliptic glass tube 23 having a desired cross-sectional shape.

In this embodiment, the both sides of the glass tube placed into the shaping unit are preliminarily sealed. Alternatively, an open glass tube may be used. In such a case, the open glass tube is placed into the shaping unit and is sealed in the shaping unit.

Steps for Making Flat Elliptic Thin Glass Tube

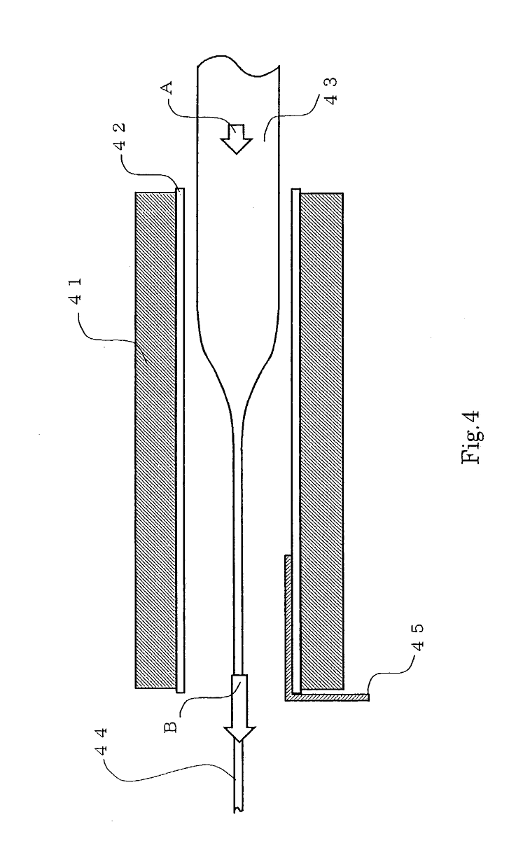

FIG. 4 is a schematic illustration of an apparatus for making a flat elliptic thin glass tube. The flat elliptic thin glass tube is formed of a flat elliptic glass tube 43 produced in the above steps. The flat elliptic glass tube 43 is heated in a heater 41 provided around a furnace wall 42 and redrawn while its shape being maintained to form a flat elliptic thin glass tube 44 having a predetermined size and shape. In an actual production apparatus, the heater 41 is divided into a plurality of segments (not shown in the drawing), each provided with a thermosensor 45 of a thermocouple. The temperature detected by the thermosensor 45 is fed back to control the current in the heater 41 for maintaining the furnace temperature within a predetermined range.

The flat elliptic glass tube 43 is fed in the direction shown by arrow A at a feed rate v, while the flat elliptic thin glass tube 44 is being drawn in the direction shown by arrow B at a drawing rate cxv where c is a drawing factor. Feeding of the flat elliptic glass tube 43 and the drawing of the flat elliptic thin glass tube 44 are performed by a plurality of rollers (not shown) disposed on both sides of the tubes. The drawing factor c depends on the material and the size of the flat elliptic glass tube 43 and is preferably in the range of 20 to 400. At a drawing factor c of less than 20, the cross-sectional homothetic ratio is about 4.5; hence, the major axis of the flat elliptic glass tube 43 must be 4.5 mm in order to form a flat elliptic thin glass tube 44 with a major axis of 1 mm. This figure is not practical. At a drawing factor c exceeding 400, the heating of the glass tube cannot follow the temperature of the heating furnace. As a result, the glass tube will break because of insufficient softening during drawing. Accordingly, the drawing factor c is preferably in the range of 20 to 400.

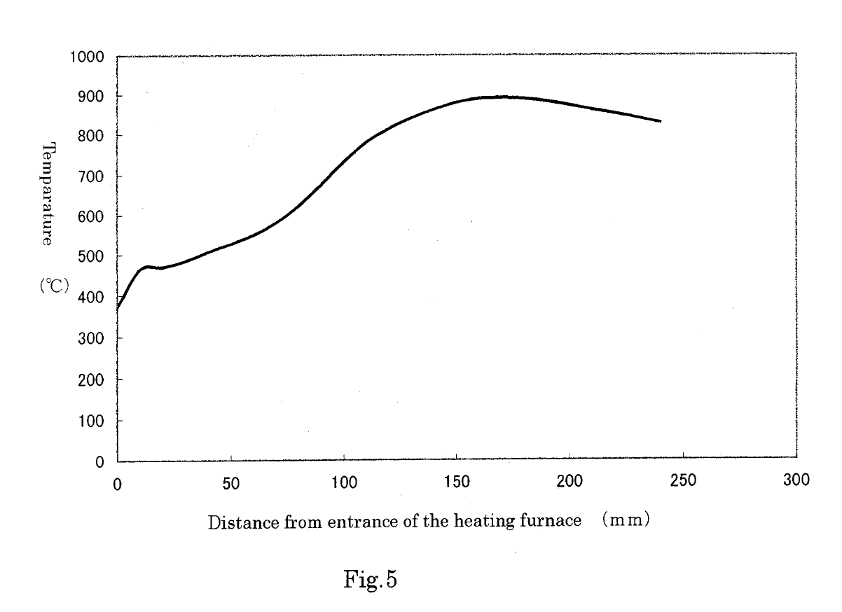

FIG. 5 is a graph showing a temperature profile in the heating furnace used in the experiment. The vertical axis represents the temperature in the heating furnace, whereas the horizontal axis is a distance from the entrance of the heating furnace. The temperature profile must have three regions, i.e., a heating region for raising the temperature of the glass tube, a holding region for holding a predetermined maximum temperature, and a cooling region for decreasing the temperature of the glass tube. In the heating region, the heating rate is in the range of 10° C./min to 300° C./min. A heating rate exceeding 300° C./min causes insufficient softening of the glass tube because of insufficient heating of the glass tube in the heating furnace. Thus, the glass would be broked by tensile force in the direction of B shown in FIG. 4 in the drawing process. A heating rate of less than 10° C./min requires an impractical longer heating furnace for sufficiently heating the glass tube.

The holding region is preferably short. At a long holding region, the softened glass tube tends to deform from the flat elliptical cross-section to a circular cross-section by surface tension of the glass. Thus, the length of the holding region is preferably 10% or less of the length of the heater of the heating furnace to maintain the flat elliptical cross-section. The temperature of the holding region is preferably in the range of 891° C.±10° C. for Pyrex and more preferably 891° C.±3° C. for Pyrex. For any other glass, the temperature is preferably in the range of 1.07 times to 1.1 times and more preferably 1.08 times to 1.09 times the softening point of the glass. If the holding region has an uneven temperature profile, the high temperature portion of the glass is drawn while the low temperature portion is not readily drawn, resulting in an uneven cross-sectional shape of the thin glass tube.

In the cooling region, the glass tube is slowly cooled until the temperature reaches the strain point (510° C. for Pyrex in this embodiment) to remove permanent strain in the glass tube.

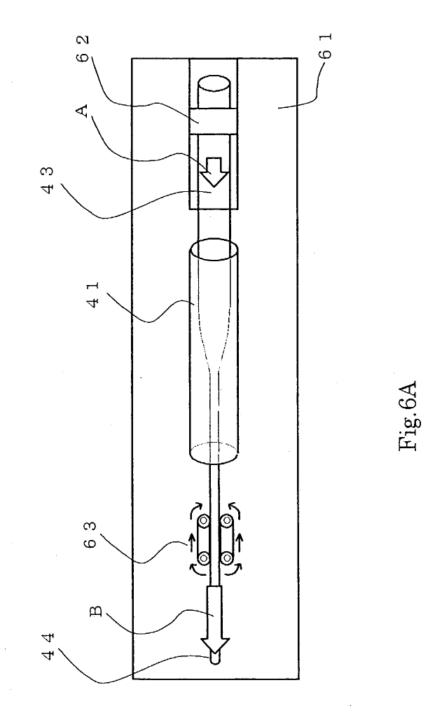

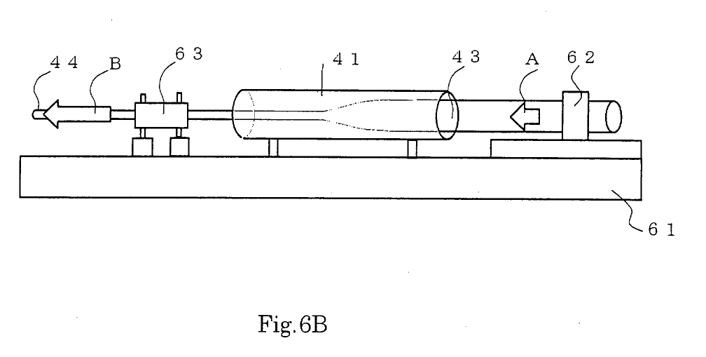

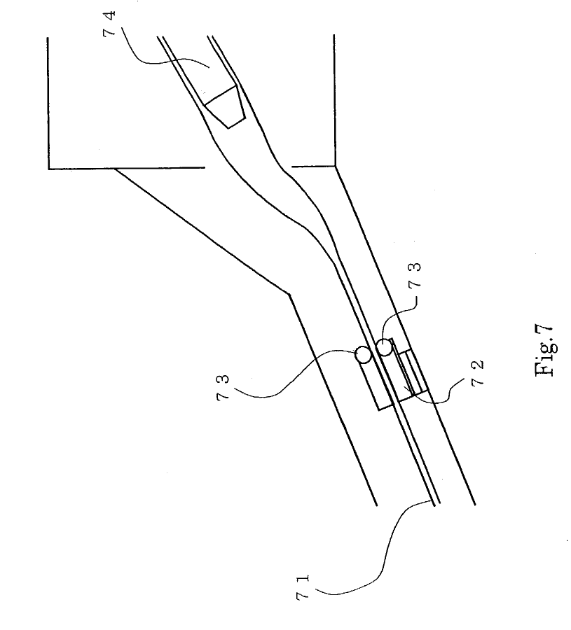

FIGS. 6A and 6B are a front view and a side view, respectively, of a redrawing apparatus 61. The redrawing apparatus 61 may be placed vertically or horizontally. The redrawing apparatus 61 has a slider 62 and a pair of drawing rollers 63. As described above, the slider 62 feeds a glass tube 43 at a feed rate v while the drawing rollers 63 draw the thin glass tube 44 at a drawing rate cxv.

In this embodiment, the apparatus is used for making a thin glass tube made of Pyrex glass. Any other glass may be used in the present invention. Examples of usable glasses include soda lime glass, borosilicate glass, and quartz glass. The temperature profile of the heating furnace is preferably determined according to the softening point of the glass used.

What is claimed is:

1. A method for making a flat elliptic thin glass tube for a discharge tube comprising the following steps of:
(a) hermetically sealing a cylindrical glass tube;
(b) heating and deforming the cylindrical glass tube in a mold by an increased internal pressure of the glass tube caused by the heating of the glass tube to form a flat elliptic glass tube, the mold having means for defining at least a dimension in the minor axis direction of the flat elliptic glass tube; and
(c) drawing while heating the flat elliptic glass tube to form the flat elliptic thin glass tube.

2. The method according to claim 1, wherein in said step (b) the cylindrical glass tube is maintained at a temperature which is 70% to 90% of the softening point of the glass tube.

3. The method according to claim 1, wherein in said step (c) the length of a region at a maximum temperature of a heating path for heating the flat elliptic glass tube is 10% or less of the total length of the heating path.

4. The method according to claim 3, wherein the heating rate is in the range of 10° C./min to 300° C./min in a heating portion of the heating path.

5. The method according to claim 3, wherein the maximum temperature of the heating path is 1.07 times to 1.1 times the softening point of the flat elliptic glass tube.

6. The method according to claim 5, wherein the heating rate is in the range of 10° C./min to 300° C./min in a heating portion of the heating path.

7. The method according to claim 3, wherein the maximum temperature of the heating path is 1.08 times to 1.09 times the softening point of the flat elliptic glass tube.

8. The method according to claim 7, wherein the heating rate is in the range of 10° C./min to 300° C./min in a heating portion of the heating path.

9. The method according to claim 1, wherein in said step (c) the feeding rate of the flat elliptic thin glass tube is 20 times to 400 times the feeding rate of the flat elliptic glass tube.
